(19) United States
(12) Patent Application Publication
(10) Pub. No.: US 2019/0130510 A1
(43) Pub. Date: May 2, 2019

(54) METHOD AND SYSTEM FOR FACILITATING ASSISTANCE TO PROSPECTIVE STUDENTS

(71) Applicant: CONNECTBUD LLC, San Jose, CA (US)

(72) Inventor: Naveen Chand BACHKETHI, San Jose, CA (US)

(21) Appl. No.: 15/798,286

(22) Filed: Oct. 30, 2017

(51) Int. Cl. G06Q 50/20; G06Q 10/10

(52) U.S. Cl. CPC G06Q 50/205; H04L 67/306; G06Q 10/1095

(57) ABSTRACT

A method and a system for facilitating assistance to prospective students are disclosed. A profile creation request is electronically received by a processor from an existing student associated with an educational institute. The profile creation request includes at least one identifier of the existing student. Authenticity of the existing student is verified based on matching the at least one identifier provided by the existing student with corresponding at least one identifier provided by the educational institute. An existing student profile creation of the existing student is facilitated. A request from a prospective student is electronically received to communicate with the existing student. A communication between the prospective student and the existing student is facilitated based at least on availability of the existing student.

### TECHNICAL FIELD

The present disclosure generally relates to educational consultation and, more particularly, to a method and system for facilitating assistance to students looking for joining institutions.

### BACKGROUND

The need for higher education has grown tremendously over recent years as higher education provides more prestigious employment, greater economic stability, and improves overall quality of life of an individual. Multiple students travel across the world for higher education quite often. A prospective student willing to take admission in an educational institute (e.g., college, university, school or any learning or specialized training center), at a different location/country from his/her hometown, may need a lot of information about the education institute. For instance, prospective student may be interested in knowing the courses being offered by a college, expenses associated with college fees, finding an accommodation in a neighborhood and the like. Generally, such information is available online on different portals such as website of the college, student forums, online blogs, international student services provided by the college and the like. Many times, the information received from various online search portals is too generic, scattered, incomplete, and may not be reliable to the satisfaction to the prospective student.

Optionally, information about a specific collage, its placements, its ecology etc., can be given by a current/existing student of the college. The prospective student may utilize social network websites to search and connect with current/existing students or other faculty members of the college to get information from them. However, such process is really taxing and it takes a great deal of time and effort to find existing students and faculty to connect with. Further, involvement of the current student for providing information to the prospective student is not rewarding to current student. Therefore, the prospective student may have to take a lot of efforts to convince the existing student for talking with him/her. Moreover, the authenticity of a person claiming to be an existing student on the social network websites is questionable as such websites do not verify if the person is really a student of the collage that he/she is claiming to be.

In view of the above, there is a need to provide solutions for facilitating assistance to prospective students such that the prospective students are enabled to easily search existing students of an educational institute. Further, there is a need to verify authenticity of the existing students. Moreover, the communication between the prospective student and the existing student is needed to be made more rewarding to the existing student such that the existing student is more committed towards allotting time for communication.

### SUMMARY

Various embodiments of the present disclosure provide methods and system for facilitating assistance to prospective students.

In an embodiment, a method includes electronically receiving a profile creation request, by a processor, from an existing student associated with an educational institute. The profile creation request includes at least one identifier of the existing student. The method includes verifying, by the processor, authenticity of the existing student based on matching the at least one identifier provided by the existing student with corresponding at least one identifier provided by the educational institute. The method further includes facilitating, by the processor, an existing student profile creation of the existing student. Furthermore, the method includes electronically receiving, by the processor, a request from a prospective student to communicate with the existing student. Thereafter, the method includes facilitating, by the processor, a communication between the prospective student and the existing student based at least on availability of the existing student.

In another embodiment, the method includes electronically facilitating, by a processor, one or more options on a UI of an electronic device associated with a prospective student for searching an existing student profile available in a database, the existing student profile created based on authenticating an existing student associated with an educational institute by matching at least one identifier provided by the existing student with corresponding at least one identifier provided by the educational institute. The method includes receiving, by the processor, selection of the existing student profile from the prospective student to communicate with the existing student. The method includes determining, by the processor, availability of the at least one existing student. The method includes facilitating, by the processor, a communication between the existing student and the prospective student based at least on the availability of the existing student. The method includes facilitating, by the processor, a reward payment from the prospective student to the existing student for allotting time for communicating with the prospective student.

In another embodiment, a system includes at least one processor and a memory. The memory having stored therein machine executable instructions, that when executed by the at least one processor, cause the system to electronically receive a profile creation request from an existing student associated with an educational institute, the profile creation request comprising at least one identifier of the existing student. The system is further caused to verify authenticity of the existing student based on matching the at least one identifier provided by the existing student with corresponding at least one identifier provided by the educational institute. The system is further caused to facilitate an existing student profile creation of the existing student. The system is further caused to electronically facilitate one or more options on a UI of an electronic device associated with a prospective student for searching the existing student profile available in a database. The system is further caused to receive selection of the existing student profile from the prospective student to communicate with the existing student. The system is further caused to facilitate a communication between the prospective student and the existing student based at least on availability of the existing student. The system is further caused to facilitate a reward payment from the prospective student to the existing student for allotting time for communicating with the prospective student.

### BRIEF DESCRIPTION OF THE FIGURES

For a more complete understanding of example embodiments of the present technology, reference is now made to the following descriptions taken in connection with the accompanying drawings in which:

FIG. 1 shows an example representation of an environment for facilitating assistance to prospective students related to at least some embodiments of the present disclosure;

FIG. 2 shows a simplified representation of a UI displayed to a prospective student for searching an existing student profile, in accordance with an example embodiment of the present disclosure;

FIG. 3 shows a simplified representation of a UI configured to provision a matched existing student profile based on information inputted by the prospective student through the UI of FIG. 2, in accordance with an example embodiment of the present disclosure;

FIG. 4 shows a simplified representation of a UI configured to display availability of an existing student, in accordance with an example embodiment of the present disclosure;

FIG. 5 shows a simplified representation of a UI configured to display a response regarding confirmation of communication, in accordance with an example embodiment of the present disclosure;

FIG. 6 is a flow diagram of a method for facilitating assistance to prospective students, in accordance with an example embodiment of the present disclosure;

FIG. 7 is a yet another flow diagram of a method for facilitating assistance to prospective students, in accordance with an example embodiment of the present disclosure;

FIG. 8 shows a block diagram representation of a system capable of implementing the various embodiments of the present disclosure; and

FIG. 9 shows a computing device capable of implementing the various embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “educational institute” used throughout the present disclosure refers to a college, an undergraduate school, a university, a postgraduate school, a distance learning institute, a training centre or any skill imparting center and the like.

The term “prospective student” used throughout the present disclosure refers to any aspiring student who is willing to seek admission in or otherwise gain information in relation to an educational institute. The prospective student includes all types of students, trainees or research associates seeking admission for higher studies or for research purposes in same or different college at the same or different location.

The term “existing student” used throughout the present disclosure refers to any person who can act as an expert (e.g., an alumni, a current student or a scholar such as a professor)) for the prospective student in solving at least few queries of the prospective student, where the queries are related to courses, accommodation, faculty, job opportunities, or any such information related to the educational institute. Accordingly, the “existing student” refers to any student currently associated with/pursing education in an educational institute (such as a college, an undergraduate school, a university, a postgraduate school, a distance learning institute, and the like).

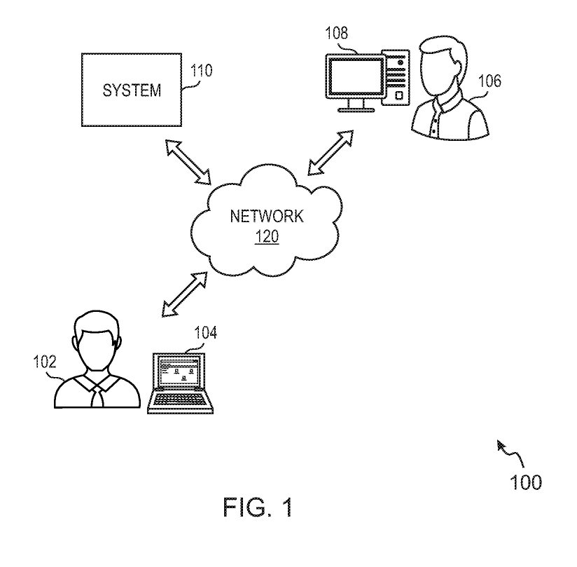

The various embodiments disclosed herein provide method and system for facilitating assistance to prospective students. More specifically, a system causes display of a UI which facilitates communication between an existing student of an educational institute and a prospective student. Both, the prospective student and the existing student are enabled to access the UI using their respective devices. The system facilitates an existing student to create a profile by entering various identification and contact information using the UI. The existing student profile is created based on verification of association of the existing student with the educational institute. The existing student profile is saved in a database of the system for later retrieval such as upon receiving a request from the prospective student to communicate with the existing student. The prospective student is facilitated with one or more options for searching the desired existing student to communicate with. Upon selection of the existing student profile, the system determines availability of the existing student and if available, sends confirmation of the communication to the prospective student. Further, post-communication, a reward payment is facilitated to be transferred from the prospective student to the existing student for allotting time for the communication. Various embodiments of the disclosure for facilitating assistance to prospective students are explained in detail herein with reference to FIGS. 1 to 9.

FIG. 1 shows an example representation of an environment 100 for facilitating assistance to prospective students related to at least some example embodiments of the present disclosure. As shown, the environment 100 depicts a prospective student 102 with his electronic device 104 (such as a laptop) and an existing student 106 with his computing device 108 (such as a desktop computer), both situated at different locations. For example, the prospective student 102 may be located in India and the existing student 106 may be located in the USA.

The prospective student 102 may seek assistance regarding the choice of an educational institute where he wants to take an admission for further studies. For example, the prospective student 102 may seek information on topics ranging from the campus and community to visa, academic support and student life activities. The prospective student 102 may need advice on living in a new place and some tips and tricks for handling the first year of university. In such scenarios, a server system/system 110 may be configured to facilitate communication between the prospective student 102 and the existing student 106 using their respective devices (hereinafter collectively referred to as user devices 104, 108).

The system 110 and the user devices 104, 108 communicate with each other over a communication network such as the network 120. The network 120 may include wired networks, wireless networks and combinations thereof. Some non-limiting examples of the wired networks may include Ethernet, local area networks (LANs), fiber-optic networks, and the like. Some non-limiting examples of the wireless networks may include cellular networks like GSM/3G/4G/5G/LTE/CDMA networks, wireless LANs, Bluetooth, Wi-Fi or ZigBee networks, and the like. An example of the combination of wired and wireless networks may include the Internet.

The system 110 may be capable of facilitating assistance to the prospective student 102 in a way that his queries related to educational institute and otherwise may be answered by the existing student 106 over the network 120. In at least one example embodiment, the system 110 may correspond to a Web-based platform (for example, a cloud platform) capable of being accessed over a communication network, such as the network 120. The Web-based platform may provision student assistance application services as a Web service accessible through a Website. In such a scenario, a plurality of existing students associated with a plurality of educational institutes and a plurality of prospective students from various locations across the globe may access the Website over the network 120 using the Web browser applications installed in their respective user devices (such as the user devices 104, 108) and thereafter use the services for communicating with one another.

In at least one example embodiment, the system 110 may also be configured to store a student assistance application program and provision instances of the application to end-users/users (such as the prospective student 102 and the existing student 106) for facilitating assistance to the prospective students. The end-users may request the system 110 to provision access to the application over the network 120. The instances of the application may thereafter be downloaded on the user devices (such as the electronic device 104 and the computing device 108) of the respective end-users in response to their request for access to the application. Alternatively, in some embodiments, the application may be factory installed within the user devices associated with the end-users and, as such, the users may not need to explicitly request the application from the system 110.

In one embodiment, the existing student 106, upon accessing the Website and/or the student assistance application (hereinafter alternatively referred to as application) associated with the system 110, may be presented with one or more UIs displayed on a display screen of the computing device 108 to send a profile creation request to the system 110. In one embodiment, the existing student 106 may be requested to fill a combination of mandatory and optional form fields using the UIs. The form fields may include, but not limited to, a full name of the existing student 106, profile picture, current university name, location of the university, domain of education, undertaken subjects of current semester, selection of current degree (from a drop-down list) for example, Associate, Bachelors, Masters, Doctorate etc., completion year of current degree, preferred language of communication, personal email address, contact/phone number, professional degree email address associated with the educational institute/university (an example of at least one identifier to verify authenticity of the existing student 106), social network profile web-links such as, but not limited to, Linkedin® profile, Facebook® profile, bank account details (such as account number and routing number for receiving payments from the prospective student 102 for allotting time for the communication), preferred time zone, availability, password and the like. In an alternate embodiment, a One-time password (OTP) on the computing device 108 of the existing student 106 may be sent which upon verification by the application may allow the existing student 106 to complete the profile creation process. In yet another embodiment, if a professor/scholar is willing to assist prospective students, he/she may also need to create a profile by sending additional information such as current working status, category of students being taught such as Associate, Bachelors, Masters or Doctorate and the like.

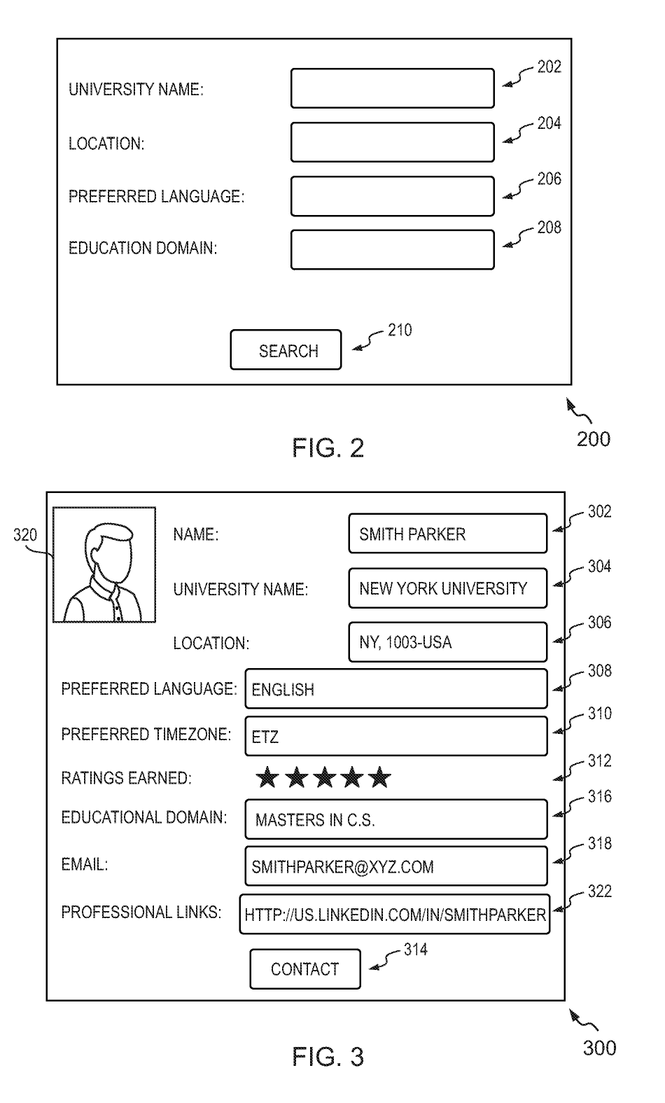

In one embodiment, the authenticity of the existing student 106 is verified based on matching the at least one identifier provided by the existing student 106 with corresponding at least one identifier provided by the educational institute. For example, the system 110 may be configured to send an email to the email address associated with the educational institute/university provided by the existing student 106 as one of the identifiers while sending the profile creation request. When the confirmation email or any other type of notification has been received from the associated university describing association of the existing student 106 with the university, the profile creation request is successfully completed and a corresponding existing student profile is created for the existing student 106. Alternatively, the educational institute may include a student photo identity card as an identifier. In one embodiment, the existing student profile is stored in a database of the system 110 and retrieved as and when a request to communicate with the associated existing student 106 is received from the prospective student 102. The various UIs capable of facilitating communication between the end users are explained hereinafter with reference to FIGS. 2-5.

FIG. 2 shows a simplified representation of a UI 200 displayed to the prospective student 102 for searching an existing student profile, in accordance with an example embodiment of the present disclosure. It is noted that the Website and/or the student assistance application may include several UIs in addition to the UI 200. In one embodiment, the prospective student 102 upon accessing the Website and/or the student assistance application associated with the system 110 may be presented with one or more UIs (not shown) displayed on a display screen of the electronic device 104 to send a profile creation request to the system 110. In one embodiment, the prospective student 102 may be requested to fill a combination of mandatory and optional form fields using the UIs. The form fields may include such as, but not limited to, a full name of the prospective student, profile picture, location, phone number, current university name, preferred language of communication, personal email address, social network profile web-links such as but not limited to Linkedin® profile, Facebook® profile, preferred payment method such as bank account details with account number for paying the existing student in return of assistance received during their communication, preferred time zone, password, and the like. In an alternate embodiment, a One-time password (OTP) on the electronic device 104 of the prospective student 102 may be sent which upon verification by the application may allow the prospective student 102 to complete the profile creation process. When the profile is successfully created, the prospective student 102 may be directed to a UI such as the UI 200, on which one or more options to search an existing student profile are facilitated.

In one embodiment, the one or more options on the UI 200 of the electronic device 104 associated with the prospective student 102 include, but not limited to, a name of the educational institute, a location of the educational institute, a preferred language for the communication and a domain of education for searching the existing student profile. The UI 200 is configured to include one or more form fields 202, 204, 206 and 208, respectively, showing corresponding text labels such as university name, location, preferred language, and education domain. The prospective student 102 using his electronic device 104 may enter relevant information in the form fields 202-208.

In an illustrative example, the prospective student 102 may enter/speak (voice input) the following information for searching a desired existing student profile.

### University Name—NYU (New York University)

### Location—USA

### Preferred Language—English

### Education Domain—Masters in Engineering

After entering the information, the prospective student 102 may click a button 210 labelled ‘Search’. The button 210 may be selected, for example by a click or a touch input, to provision a request for searching a desired existing student profile.

The UI 200 including form fields 202 to 208 is depicted herein for illustration purposes and the present disclosure is not limited to these form fields only. The UI 200 may include more or fewer form fields, and in different configurations. Moreover, in some embodiments, one or more form fields may be implemented as free form text boxes or the form fields may include drop-down menus or may be associated with check-boxes to enable user selection of options. In at least one example embodiment, the system 110 may be configured to receive the details provided by the prospective student 102 as input into the form fields 202-208 upon selection of the button 210, and compute an analysis to retrieve a matching existing student profile. In an embodiment, the system 110 may be in operative communication with a database configured to store a plurality of existing student profiles and cause display of a UI capable of provisioning a matched existing student profile. Such a UI is explained with reference to FIG. 3.

FIG. 3 shows a simplified representation of a UI 300 configured to provision a matched existing student profile based on information inputted by the prospective student 102 through the UI 200 of FIG. 2, in accordance with an example embodiment of the disclosure. The UI 300 is configured to display a plurality of text labels with corresponding information fields. For example, text label—name corresponds to ‘Smith Parker’ (see, information field 302) being the name of an existing student (such as the existing student 106 of FIG. 1) associated with the existing student profile. Text label—university name corresponds to ‘New York University’ (see, information field 304), text label—location corresponds to ‘NY, 1003-USA’ (see, information field 306), text label—preferred language corresponds to ‘English’ (see, information field 308), text label—preferred time zone belongs to ‘ETZ’ (Eastern Time Zone) (see, information field 310), text label—ratings earned corresponds to five starts (see, information field 312), text label —educational domain (i.e., stream name) corresponds to ‘Masters in C.S.’ (Computer Science) (see, information field 316), text label—email corresponds to ‘smithparker@xyz.com’ (see, information field 318) and text label—professional links corresponds to ‘http://us.linkedin.com/in/smithparker’ (see, information field 322). The UI 300 is further depicted to include a profile picture 320 of the existing student if he has uploaded one during creation of the profile.

In one embodiment, the prospective student 102 may review this information on his electronic device 104 and may select a button 314 labeled ‘Contact’. The button 314 may be selected, for example by a click or a touch input, to provision a selection of the existing student profile by the prospective student 102 to communicate with the corresponding existing student (i.e. Smith Parker). In one embodiment, the prospective student 102 may be enabled to select a different existing student profile other than the provisioned existing student profile by selecting buttons labelled ‘Search again’, ‘next’ or ‘previous’ (not shown) on the UI 300. Such selection may direct the prospective student 102 to the UI 200 for entering new information in the form fields or alternatively to a new UI showing different existing profile based on the same information provided by the prospective student 102 using the UI 200.

In at least one embodiment, the prospective student 102 may be requested to provide ratings for the communication with the existing student. The ratings may be provided by the prospective student 102 on the completion of the call with the existing student or electronically by a click or a touch input through the website or the student assistance application (as shown by the information field 312). The system 110 may be configured to re-compute ratings of the existing student based on the ratings received from the prospective student 102. Further, the system 110 may be configured to provision the re-computed ratings on the existing student profile associated with the existing student.

More specifically, the information field 312 displays five stars. The prospective student 102 may provide an input to select a number of stars that corresponds to the prospective student's assessment of the communication with the existing student. In an embodiment, selection of five stars may imply that the communication/approach of the existing student as excellent and lower rating of stars may imply progressively inferior quality of communication. For example, the selection of one star may imply that the existing student did not properly answer all the queries of the prospective student 102 or did not receive the scheduled call. It is noted that the UI 300 may include other mechanisms for receiving prospective student's input corresponding to provide ratings of communication. For example, the UI 300 may display a sliding scale and the prospective student 102 may slide the scale to rate the communication on a scale of 1 to 5, with rating of 1 being the highest rating and 5 being the lowest rating. Alternatively, the UI 300 may include a form field capable of receiving a numerical input corresponding to the ratings on a scale of 1 to 5.

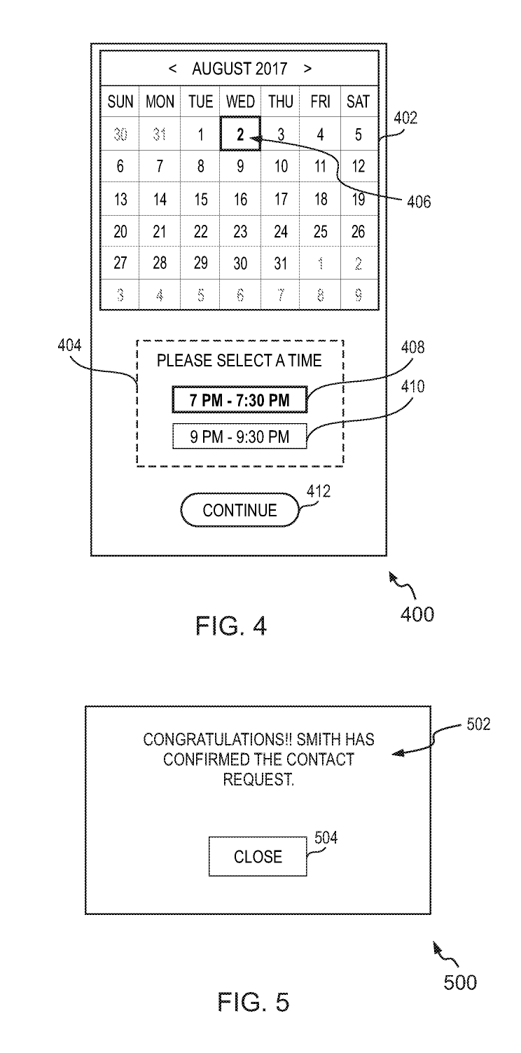

In an embodiment, the selection of the button 314 ‘Contact’ may cause provisioning of the request to the system 110. It is noted that the communication between the application/Website on the electronic device 104 associated with the prospective student 102 and the system 110 may be performed in form of web requests. The web requests may be embodied in form of a data signal capable of being securely transmitted over a communication network, such as the network 120. In one embodiment, the system 110 is configured to determine availability of the existing student based on receiving selection of the existing student profile from the prospective student 102 by clicking the button 314 ‘Contact’. The system 110 is further configured to display a UI showing availability of the existing student. Such a UI is explained in detail with reference to FIG. 4.

FIG. 4 shows a simplified representation of a UI 400 configured to display availability of an existing student, in accordance with an example embodiment of the present disclosure. As shown, the UI 400 enables the prospective student 102 to access a calendar view 402 for the month of August. The calendar view 402 depicts a date 2^{nd} of August (exemplarily depicted using box 406) in a highlighted form, implying Smith Parker is only available for communication on Wednesday, 2^{nd} of August. It is understood that only one day is shown in the example embodiment as availability for Smith Parker for simplicity purposes, and it is noted that an existing student may be available on multiple days for allotting time for communication. Further, a time slot view 404 depicting various time slots such as 7.0 pm-7.30 pm and 9.0 pm to 9.30 pm (exemplarily depicted using boxes 408 and 410 respectively) may be displayed for selection by the prospective student 102. The UI 400 exemplarily shows date 2^{nd} of August, 2107 and time slot 7.0 pm-7.30 pm selected by the prospective student 102 to communicate with the existing student (Smith Parker). Post selection, the prospective student 102 may select a button 412 labeled ‘Continue’ to confirm the communication request. In one embodiment, there may be provided a button labeled ‘Cancel’ (not shown) to cancel the communication request, or a button labeled ‘edit’ to make changes in the selection of date and time for the communication request. Such selection may direct the prospective student 102 to a home page view for initiating the search process again.

In an embodiment, the selection of the button 412 ‘Continue’ may cause provisioning of the request to the system 110. It is noted that the communication between the application/Website on the electronic device 104 associated with the prospective student 102 and the system 110 may be performed in form of web requests.

In one embodiment, the system 110 may be configured to trigger a notification to the selected existing student of the request to communicate received from the prospective student 102. The notification may be provisioned on one of the UIs of the computing device (such as the computing device 108) being used by the selected existing student. In other embodiments, a customer representative may call on a contact number provided by the existing student while creating the profile to notify and receive confirmation about the communication request sent by the prospective student 102. In one embodiment, upon communication confirmation received from the existing student, the system 110 is configured to update the calendar view 402 associated with the profile of the existing student. In one embodiment, the existing student and/or the prospective student are enabled to send a rescheduling request of the communication to the system 110. For instance, in response to the rescheduling request received from the existing student, the system 110 may be configured to notify the rescheduled timings to the prospective student and receive his confirmation.

In an alternate embodiment, the system 110 may be configured to provide a UI (not shown) corresponding to ‘connect me now’ feature of the application. Wherein, instead of displaying future availability of existing students, the system 110 may display currently available (online) status of a number of existing students (e.g., scholars, experts, alumni and the like) from various educational institutes, and a number of prospective students looking for communication with one of the existing students through respective UIs on respective devices being used by them. A prospective student using a UI, such as the UI 200, may enter information (such as university name, location and the like) to connect with one of currently online existing students. Further, the system 110 may display charges per 30-60 minutes of call/communication to be facilitated between the users. For example, if the college is in ASIA, the call rate may be $4 for an Expert and $10 for a Professor. A service charge of 25% fees may be deducted by the system 110 for facilitation of the call. Upon receiving information entered by the prospective student using a UI such as the UI 200, the system 110 may broadcast a message of a prospective student willing to communicate at the moment to each online existing student matching the criteria.

When one of the online/currently available existing students accepts the request, the communication is immediately facilitated and predetermined amount of money is deducted from the account of prospective student. Further, the system 110 is configured to keep searching for the matching profiles of the online existing students for a predetermined period of time, for example, 60 seconds. If unable to find, the system 110 displays a message on the electronic device of the prospective student such as ‘existing student not available’.

FIG. 5 shows a simplified representation of a UI 500 configured to display a response regarding confirmation of communication, in accordance with an example embodiment of the disclosure. As explained with reference to FIG. 4, the system 110 may be configured to notify the existing student and the prospective student of the communication confirmation. The confirmation may be communicated to the users by causing a display of an UI on a display screen of the user devices associated with the users. Alternatively, the users may be notified by an email or a text message about such confirmation. The UI 500 exemplarily depicts a message 502 including text “Congratulations!! Smith has confirmed the contact request.” displayed on the display screen of the electronic device 104 being used by the prospective student 102.

The UI 500 further depicts a button 504 displaying text “Close”. The prospective student 102 may select the button 504 to close the UI 500. In one embodiment, when the communication request is confirmed, the selection of the button 504 may direct the prospective student 102 to another UI showing details such as for example, date and time of communication, preferred mode of communication (such as a voice call, a video call and a chat) and the like. In one embodiment, the users may be enabled to communicate with each other via a voice call, a video call or a chat session using services of the student assistance application. In another embodiment, the users may use their mobile phones to perform a normal phone call facilitated by their network providers or may utilize one or more other applications to communicate with each other. Irrespective of the communication mode, the prospective student 102 may be requested to provide ratings for the communication with the existing student once the communication is over and the re-computed ratings may be provisioned on the profile of the existing student as explained with reference to FIG. 3. In another embodiment, at the end of the call, both the prospective student 102 and the existing student may be requested by the system 110 to rate ‘Call Quality’, and provide ‘Feedback about the other user’ using their respective devices.

In one embodiment, upon display of the message 502, the system 110 is further configured to deduct a predetermined amount of money using the preferred payment method provided by the prospective student 102 while creating the profile. The system 110 is configured to hold the payment transaction until the communication is over. After the completion of the call/communication, a predetermined portion of the amount is deducted by the system 110 as a service fee (for example, 10%-25%) and the remaining amount is transferred to the existing student (using the account number and routing number details) as a reward payment for allotting time for communicating with the prospective student 102. In another embodiment, the system 110 may not store account information (such as credit card information, bank account details) of the users, rather it may require the users to maintain minimum predetermined amount of balance in their respective profiles. Accordingly, the existing student may get paid, for example, on 28^{th} of every month by maintaining a minimum amount in the profile. Alternatively, the existing student can also provide an address of charity or his own address where the monthly cheque may be sent.

In one embodiment, the users are enabled to send a cancellation request of the (scheduled) communication before a predefined time period (e.g., 24 hours) giving a reason for the cancellation request. The system 110, upon receiving such request, is configured to facilitate cancellation of the communication and notify the users of the same. In at least one embodiment, the system 110 is configured to facilitate a reminder notification to the prospective student and the existing student in advance (at one or more scheduled times prior to) of the (scheduled) communication. For example, the system 110 may send an email or a text message 15 minutes before the call to remind the users of the upcoming call.

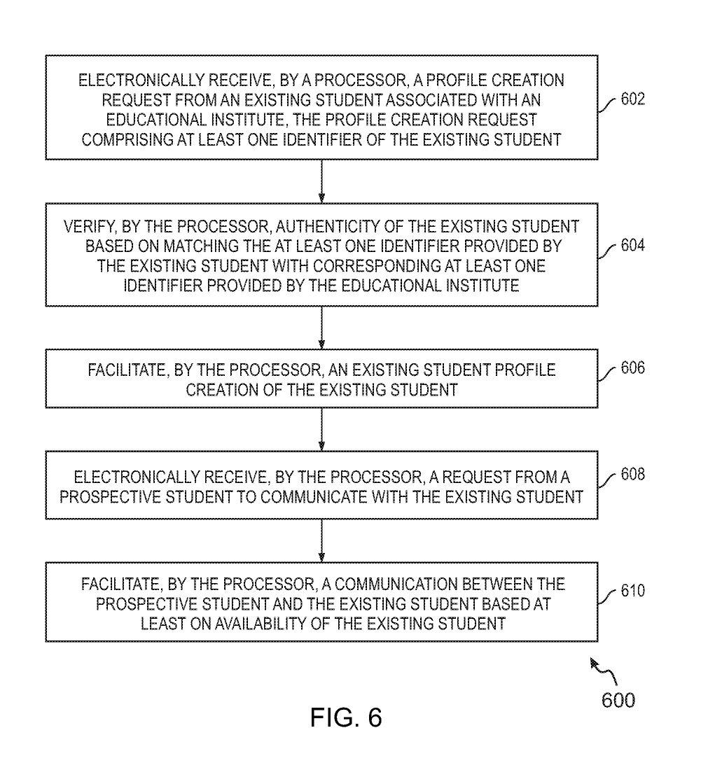

FIG. 6 is a flow diagram 600 of a method for facilitating assistance to prospective students, in accordance with an example embodiment of the disclosure. The various steps and/or operations of the flow diagram, and combinations of steps/operations in the flow diagram, may be implemented by, for example, hardware, firmware, a processor, circuitry and/or by the system 110 of FIG. 1 and/or by a different electronic device associated with the execution of software that includes one or more computer program instructions.

At 602, a profile creation request is electronically received by a processor from an existing student associated with an educational institute. The profile creation request includes at least one identifier of the existing student. The processor may be a component of a system such as the system 110 configured to electronically receive the profile creation request from the existing student. In one embodiment, the profile creation request is generated from a UI of a computing device (such as the computing device 108 of FIG. 1) associated with the existing student (such as the existing student 106 of FIG. 1).

At 604, authenticity of the existing student is verified based on matching the at least one identifier provided by the existing student with corresponding at least one identifier provided by the educational institute. In one example embodiment, the at least one identifier provided by the existing student may be an email address associated with the educational institute. In another example embodiment, the authenticity verification is done by sending an email to the email address associated with the educational institute. Identifier may also include examples of other information such as student ID number issued by the educational institute, enrolment number, or a student profile created by the educational institute.

At 606, an existing student profile creation of the existing student is facilitated. The existing student profile creation is facilitated based on verification of the association (e.g., verification of identifier) of the existing student with the educational institute.

At 608, a request is electronically received from a prospective student to communicate with the existing student. In an illustrative example, the request for communication may refer to seeking information about local food, grocery stores, weather, transportation, banks, mobile phone services, resident life, student services on campus and the like.

At 610, a communication between the prospective student and the existing student is facilitated based at least on availability of the existing student. In one example embodiment, the prospective student may be a current student of an educational institute who wish to communicate with another existing student of the same educational institute. For example, a junior student may seek information from a senior student of the same educational institute regarding which subjects to choose in higher semester. In such scenarios, the system 110 may be configured to facilitate communication between existing students of the educational institute.

In one embodiment, additional information associated with all the completed calls/chats such as call duration, name of the existing student (who was part of the communication), ratings and the like may be displayed on a UI (not shown) as ‘Call-history page’. Further, there may be provided a dispute option for each call for a predetermined time-period for user selection. User may click the dispute option to initiate dispute for a specific call. Upon receiving user selection, the system 110 may be configured to facilitate a dropdown list with options of categorizing the dispute. For example, the user being the prospective student may raise dispute for the less amount of time allotted by the existing student or for receiving vague information from the existing student for the specific questions asked and the like. Upon selecting appropriate dispute option, or defining one by writing, the user may click on a submit button. Subsequently, the system 110 receives the dispute-message and resolves the concern of the user. In one embodiment, the dispute-message is also sent to the existing student by the system 110 and the existing student is requested to acknowledge the dispute.

In another example embodiment, there may be provided a referral discount by the system 110 to the users of the application. For example, each user referring the application to another un-registered person may receive $1 worth (10 points) added in his/her account as soon the referred person registers and the registered person also receives $1 credit in his account.

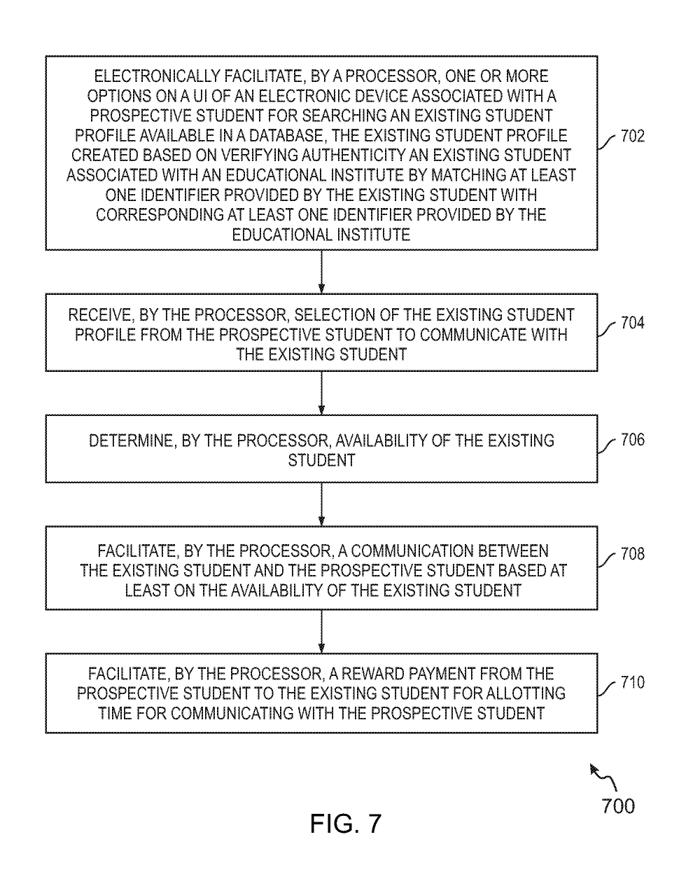

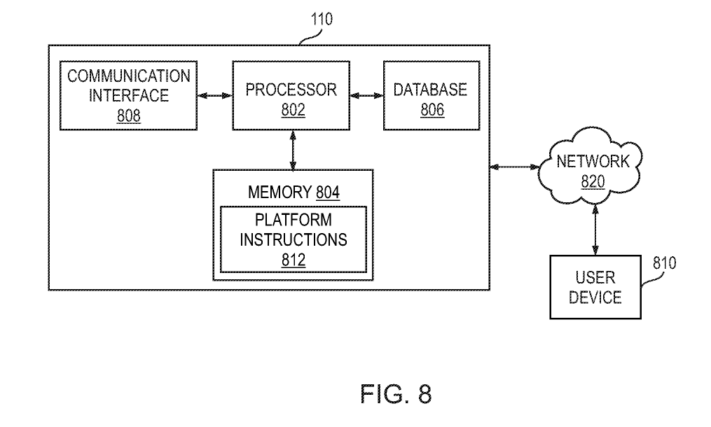

FIG. 7 is a yet another flow diagram 700 of a method for facilitating assistance to prospective students, in accordance with an example embodiment of the disclosure. The various steps and/or operations of the flow diagram, and combinations of steps/operations in the flow diagram, may be implemented by, for example, hardware, firmware, a processor, circuitry and/or by the system 110 of FIG. 1 and/or by a different electronic device associated with the execution of software that includes one or more computer program instructions.

At 702, one or more options on a UI of an electronic device associated with a prospective student are electronically facilitated for searching an existing student profile available in a database. The existing student profile is created based on verifying authenticity of an existing student associated with an educational institute by matching at least one identifier provided by the existing student with corresponding at least one identifier provided by the educational institute. A system (such as the system 110) may be configured to facilitate the one or more options such as a name of the educational institute, a location of the educational institute, a preferred language for the communication and a domain of education for searching the existing student profile as explained with reference to UI 200 of FIG. 2.

At 704, selection of the existing student profile is received from the prospective student to communicate with the existing student. As explained with reference to FIG. 3, the system 110 may be configured to provision a matched existing student profile on UI 300 based on the information inputted by the prospective student on the UI 200. In one embodiment, the prospective student may electronically send a profile creation request to the system 110. The system 110 may request the prospective student to enter information of a payment method for communicating with the existing student.

At 706, availability of the at least one existing student is determined. As explained with reference to FIG. 4, the UI 400 is depicted to display availability of the existing student for selection of the prospective student.

At 708, a communication between the existing student and the prospective student is facilitated based at least on the availability of the existing student. In one embodiment, the prospective student and/or the existing student may be enabled to send a reschedule request and/or a cancelation request (before a predetermined time period) and the system 110 may be configured to facilitate such request and notify the other user of the same.

At 710, a reward payment from the prospective student is facilitated to the existing student for allotting time for communicating with the prospective student.

The disclosed methods 600 and 700 or one or more operations of the methods 600 and 700 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

FIG. 8 shows a block diagram representation of the system 110 capable of implementing the various embodiments of the present disclosure. The system 110 includes at least one processor 802, a memory 804, a database 806 and a communication interface 808 for facilitating assistance to prospective students. The processor 802 is operatively coupled with the memory 804, the database 806 and the communication interface 808. In at least one embodiment, the system 110 may be accessible to user electronic devices, such as a user device 810, through a communication network, such as the network 820.

The database 806 is any computer-operated hardware suitable for storing and/or retrieving data, such as, but not limited to, the existing student profile, the prospective student profile, updated ratings associated with the existing student, information of the payment method inputted by the prospective student and the like. The database 806 may include multiple storage units such as hard disks and/or solid-state disks in a redundant array of inexpensive disks (RAID) configuration. The database 806 may include a storage area network (SAN) and/or a network attached storage (NAS) system.

The processor 802 is capable of executing the stored machine executable instructions (hereinafter referred to as platform instructions 812) in the memory 804 or within the processor 802 or any storage location accessible to the processor 802. The processor 802 is configured to perform the various operations as explained with reference to methods 600 and 700. For example, the processor 802 is configured to electronically receive a profile creation request from an existing student associated with an educational institute. The profile creation request may be sent from the user device 810. The processor 802 is further configured to verify authenticity of the existing student based on matching the at least one identifier (such as email address associated with the educational institute) provided by the existing student with corresponding at least one identifier provided by the educational institute. The processor 802 is configured to facilitate existing student profile creation of the existing student based on the verification. The processor 802 is configured to electronically facilitate one or more options on a UI of an electronic device (such as the user device 810) associated with a prospective student for searching the existing student profile available in the database 806. The processor 802 is configured to facilitate a communication between the prospective student and the existing student using the communication interface 808 based at least on availability of the existing student and based on receiving selection of the existing student profile from the prospective student to communicate with the existing student. Further, the processor 802 is configured to facilitate a reward payment from the prospective student to the existing student for allotting time for communicating with the prospective student.

In an embodiment, the processor 802 may be embodied as one or more of various processing devices, such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The memory 804 may be configured to store the platform instructions 812 (e.g., instructions for the student assistance application program) for the processor 802 to execute for facilitating assistance to prospective students. The memory 804 is a storage device embodied as one or more volatile memory devices, one or more non-volatile memory devices, and/or a combination of one or more volatile memory devices and non-volatile memory devices, for storing micro-contents information and instructions. The memory 804 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash ROM, RAM (random access memory), etc.).

The communication interface 808 is configured to facilitate communication between the system 110 and user devices associated with users, such as prospective students and the existing students The communication interface 808 is configured to cause display of UIs on the user devices (such as the user devices 104, 108 of FIG. 1), such as the UIs 200, 300, 400, and 500, thereby enabling the users to communicate with one another. The processor 802, in conjunction with the communication interface 808, may be configured to send reminder notifications to the prospective students and the existing students before the scheduled communication. The communication interface 808 may also be configured to send cancellation and/or rescheduling notification to users based on cancellation and/or rescheduling request sent by either of the users. The communication may be achieved over a communication network, such as the network 820.

In at least some example embodiment, the system 110 may include an I/O module (not shown in FIG. 8) configured to receive inputs from and provide outputs to the users of the system 110. To that effect, the I/O module may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a UI display (such as a light emitting diode display, a thin-film transistor (TFT) display, a liquid crystal display, an active-matrix organic light-emitting diode (AMOLED) display, etc.), a microphone, a speaker, a ringer, a vibrator, and the like.

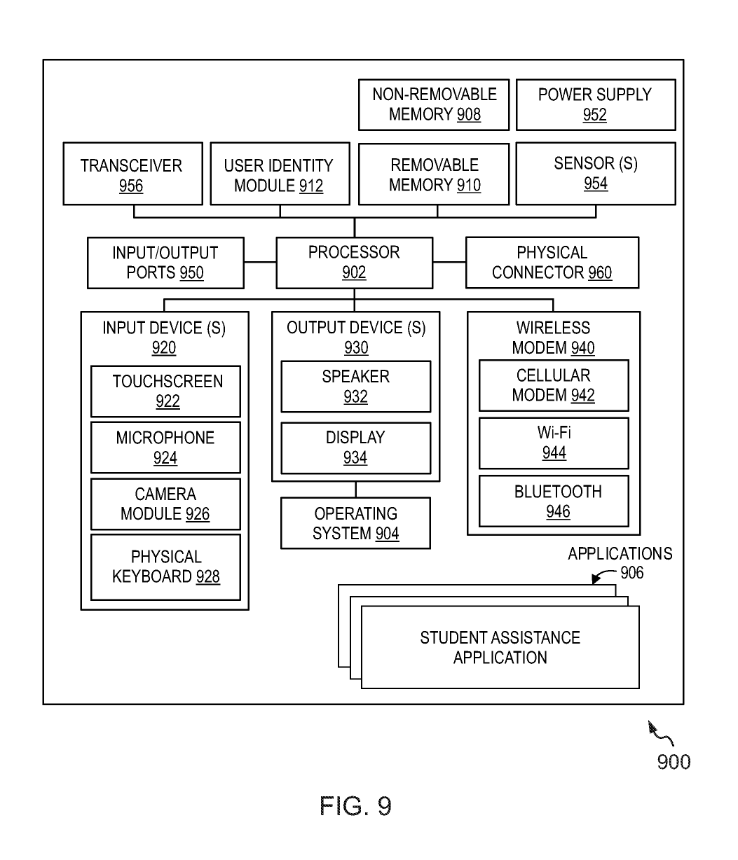

FIG. 9 illustrates a computing device 900 capable of implementing the various embodiments of the present disclosure. In an embodiment, the various operations performed by the system 110 may be implemented using an application in a computing device, such as the computing device 900. For example, the computing device 900 may correspond to a device corresponding to a prospective student (e.g., the electronic device 104) and/or an existing student (e.g., the computing device 108). The computing device 900 is depicted to include one or more applications 906, including an application for student assistance, which serves as an instance of the application downloaded from the system 110 and capable of communicating with the system 110 to facilitate student assistance.

It should be understood that the computing device 900 as illustrated and hereinafter described is merely illustrative of one type of device and should not be taken to limit the scope of the embodiments. As such, it should be appreciated that at least some of the components described below in connection with that the computing device 900 may be optional and thus in an example embodiment may include more, less or different components than those described in connection with the example embodiment of the FIG. 9. As such, among other examples, that the computing device 900 could be any of a mobile electronic devices, for example, cellular phones, tablet computers, laptops, mobile computers, desktop computers, personal digital assistants (PDAs), mobile televisions, mobile digital assistants, or any combination of the aforementioned, and other types of communication or multimedia devices.

The illustrated computing device 900 includes a controller or a processor 902 (e.g., a signal processor, microprocessor, ASIC, or other control and processing logic circuitry) for performing such tasks as signal coding, data processing, image processing, input/output processing, power control, and/or other functions. An operating system 904 controls the allocation and usage of the components of the computing device 900 and support for one or more applications programs (see, applications 906), such as student assistance application, that implements one or more of the innovative features described herein. In addition to student assistance application, the applications 906 may include common mobile computing applications (e.g., telephony applications, email applications, calendars, contact managers, web browsers, messaging applications) or any other computing application. The student assistance application, in at least one example embodiment, may be configured to provide the logic to facilitate student assistance, as explained with reference to FIGS. 1 to 5.

The illustrated computing device 900 includes one or more memory components, for example, a non-removable memory 908 and/or removable memory 910. The non-removable memory 908 can include RAM, ROM, flash memory, a hard disk, or other well-known memory storage technologies. The removable memory 910 can include flash memory, smart cards, or a Subscriber Identity Module (SIM). The one or more memory components can be used for storing data and/or code for running the operating system 904 and the applications 906. The one or more memory components can be used for storing data and/or code for running the operating system 904 and the applications 906. The computing device 900 may further include a user identity module (UIM) 912. The UIM 912 may be a memory device having a processor built in. The UIM 912 may include, for example, a subscriber identity module (SIM), a universal integrated circuit card (UICC), a universal subscriber identity module (USIM), a removable user identity module (R-UIM), or any other smart card. The UIM 912 typically stores information elements related to a mobile subscriber. The UIM 912 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The computing device 900 can support one or more input devices 920 and one or more output devices 930. Examples of the input devices 920 may include, but are not limited to, a touch screen 922 (e.g., capable of capturing finger tap inputs, finger gesture inputs, multi-finger tap inputs, multi-finger gesture inputs, or keystroke inputs from a virtual keyboard or keypad), a microphone 924 (e.g., capable of capturing voice input), a camera module 926 (e.g., capable of capturing still picture images and/or video images) and a physical keyboard 928. Examples of the output devices 930 may include, but are not limited to a speaker 932 and a display 934. Other possible output devices (not shown in the FIG. 9) can include piezoelectric or other haptic output devices. Some devices can serve more than one input/output function. For example, the touch screen 922 and the display 934 can be combined into a single input/output device.

A wireless modem 940 can be coupled to one or more antennas (not shown in the FIG. 9) and can support two-way communications between the processor 902 and external devices, as is well understood in the art. The wireless modem 940 is shown generically and can include, for example, a cellular modem 942 for communicating at long range with the mobile communication network, a Wi-Fi compatible modem 944 for communicating at short range with an external Bluetooth-equipped device or a local wireless data network or router, and/or a Bluetooth-compatible modem 946. The wireless modem 940 is typically configured for communication with one or more cellular networks, such as a GSM network for data and voice communications within a single cellular network, between cellular networks, or between the computing device 900 and a public switched telephone network (PSTN).

The computing device 900 can further include one or more input/output ports 950, a power supply 952, one or more sensors 954 for example, an accelerometer, a gyroscope, a compass, or an infrared proximity sensor for detecting the orientation or motion of the computing device 900, a transceiver 956 (for wirelessly transmitting analog or digital signals) and/or a physical connector 960, which can be a USB port, IEEE 1294 (FireWire) port, and/or RS-232 port. The illustrated components are not required or all-inclusive, as any of the components shown can be deleted and other components can be added.

Various example embodiments offer, among other benefits, techniques for efficient student assistance. The methods and systems disclosed herein facilitate a seamless communication between the prospective student and the existing student of an educational institute. Various embodiments assist prospective student reach his/her educational goals by providing necessary assistance through facilitation of a dedicated phone call with an existing student of the educational institute. During the dedicated call, the prospective student can ask general regulatory information or application and admission procedures of the educational institute to the existing student. For instance, the prospective student can ask how to combine studying and working, which degree program to choose, which subject combinations to pick, how to change a subject, which health insurance to buy, problems faced by existing student during his/her studies, and the like. The existing student can share important experiences, answer questions or address concerns and provide insight into university life. Thus, the prospective student does not need to review websites of universities or contact admissions offices by phone or email to find out about the queries which is a time consuming process. Various embodiments of the present disclosure enables the prospective student receive all the assistance and the existing student receive a reward payment in return for providing the necessary information such that both the parties to the communication are satisfied.

Although the disclosure has been described with reference to specific exemplary embodiments, it is noted that various modifications and changes may be made to these embodiments without departing from the broad spirit and scope of the disclosure. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the systems and methods may be embodied using transistors, logic gates, and electrical circuits (for example, application specific integrated circuit (ASIC) circuitry and/or in Digital Signal Processor (DSP) circuitry).

Particularly, the system 110 and its various components may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or computer to perform one or more operations (for example, operations explained herein with reference to FIGS. 6 and 7). A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Various embodiments of the disclosure, as discussed above, may be practiced with steps and/or operations in a different order, and/or with hardware elements in configurations, which are different than those which, are disclosed. Therefore, although the disclosure has been described based upon these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
electronically receiving a profile creation request, by a processor, from an existing student associated with an educational institute, the profile creation request comprising at least one identifier of the existing student;
verifying, by the processor, authenticity of the existing student based on matching the at least one identifier provided by the existing student with corresponding at least one identifier provided by the educational institute;
facilitating, by the processor, an existing student profile creation of the existing student;
electronically receiving, by the processor, a request from a prospective student to communicate with the existing student; and
facilitating, by the processor, a communication between the prospective student and the existing student based at least on availability of the existing student.

2. The method of claim 1, wherein the profile creation request is generated from a User Interface (UI) of a computing device associated with the existing student.

3. The method of claim 1, wherein the at least one identifier provided by the existing student comprises an email address associated with the educational institute.

4. The method of claim 1, further comprising:
receiving a rescheduling request of the communication by at least one of the prospective student and the existing student; and
facilitating rescheduling of the communication based on the rescheduling request.

5. The method of claim 1, further comprising:
facilitating a reminder notification to the prospective student and the existing student at one or more scheduled times prior to the communication.

6. The method of claim 1, further comprising:
receiving a cancellation request of the communication at least a predefined time period before a time of the communication by at least one of the prospective student and the existing student; and
facilitating cancellation of the communication based on the cancellation request.

7. The method of claim 1, further comprising:
electronically requesting the prospective student to provide ratings for the communication with the existing student;
re-computing ratings of the existing student based on the ratings received from the prospective student; and
provisioning the re-computed ratings on the existing student profile associated with the existing student.

8. The method of claim 1, further comprising setting up the communication between the prospective student and the existing student through at least one of a voice call, a video call and a chat.

9. A computer-implemented method, comprising:
electronically facilitating, by a processor, one or more options on a User Interface (UI) of an electronic device associated with a prospective student for searching an existing student profile available in a database, the existing student profile created based on verifying authenticity of an existing student associated with an educational institute by matching at least one identifier provided by the existing student with corresponding at least one identifier provided by the educational institute;
receiving, by the processor, a selection of the existing student profile from the prospective student to communicate with the existing student;
determining, by the processor, availability of the existing student;
facilitating, by the processor, a communication between the existing student and the prospective student based at least on the availability of the existing student; and
facilitating, by the processor, a reward payment from the prospective student to the existing student for allotting time for communicating with the prospective student.

10. The method of claim 9, further comprising:
electronically receiving a profile creation request from the prospective student, the profile creation request comprising information of a payment method for communicating with the existing student.

11. The method of claim 9, wherein the one or more options on the UI of the electronic device associated with the prospective student comprise a name of the educational institute, a location of the educational institute, a preferred language for the communication and a domain of education for searching the existing student profile.

12. A system, comprising:
at least one processor; and
a memory having stored therein machine executable instructions, that when executed by the at least one processor, cause the system to:
electronically receive a profile creation request from an existing student associated with an educational institute, the profile creation request comprising at least one identifier of the existing student;
verify authenticity of the existing student based on matching the at least one identifier provided by the existing student with corresponding at least one identifier provided by the educational institute;
facilitate an existing student profile creation of the existing student;
electronically facilitate one or more options on a User Interface (UI) of an electronic device associated with a prospective student for searching the existing student profile available in a database;
receive a selection of the existing student profile from the prospective student to communicate with the existing student;
facilitate a communication between the prospective student and the existing student based at least on availability of the existing student; and
facilitate a reward payment from the prospective student to the existing student for allotting time for communicating with the prospective student.

13. The system of claim 12, wherein the profile creation request is generated from a UI of a computing device associated with the existing student.

14. The system of claim 12, wherein the at least one identifier provided by the existing student comprises an email address associated with the educational institute.

15. The system of claim 12, wherein the system is further caused to:
receive a rescheduling request of the communication by at least one of the prospective student and the existing student; and
facilitate rescheduling of the communication based on the rescheduling request.

16. The system of claim 12, wherein the system is further caused to:
facilitate a reminder notification to the prospective student and the existing student at one or more scheduled times prior to the communication.

17. The system of claim 12, wherein the system is further caused to:
receive a cancellation request of the communication at least a predefined time period before a time of the communication by at least one of the prospective student and the existing student; and
facilitate cancellation of the communication based on the cancellation request.

18. The system of claim 12, wherein the system is further caused to:
electronically request the prospective student to provide ratings for the communication with the existing student;
re-compute ratings of the existing student based on the ratings received from the prospective student; and
provision the re-computed ratings on the existing student profile associated with the existing student.

19. The system of claim 12, wherein the system is further caused to set up communication between the prospective student and the existing student through at least one of a voice call, a video call and a chat.

20. The system of claim 12, wherein the system is further caused to:
electronically receive a profile creation request from the prospective student, the profile creation request comprising information of a payment method for communicating with the existing student.
